(19) United States
(12) Patent Application Publication
(10) Pub. No.: US 2026/0170061 A1
(43) Pub. Date: Jun. 18, 2026

(54) INFORMATION PROCESSING METHOD, APPARATUS AND DEVICE

(71) Applicant: Beijing Zitiao Network Technology Co., Ltd., Beijing (CN)

(72) Inventors: Kai YAN, Beijing (CN); Yuqi SHEN, Beijing (CN); Xing SHI, Beijing (CN)

(21) Appl. No.: 19/416,876

(22) Filed: Dec. 11, 2025

(30) Foreign Application Priority Data
Dec. 16, 2024 (CN) 202411855850.X

(51) Int. Cl. G06F 16/903; G06F 16/9038

(52) U.S. Cl. CPC G06F 16/90335; G06F 16/9038

(57) ABSTRACT

Embodiments of the present disclosure provide an information processing method, an apparatus, and a device. The method includes: receiving search content input by a user, performing search according to the search content, and invoking a content generation model to generate reply content for the search content; parsing whether the user has a need to acquire the reply content according to the search content, and determining an arrangement order of a search result and the reply content according to a parsing result; and displaying the search result and the reply content according to the arrangement order.

### CROSS-REFERENCE TO RELATED APPLICATIONS

This application claims priority to Chinese Patent Application No. 202411855850.X, entitled “INFORMATION PROCESSING METHOD, APPARATUS AND DEVICE”, and filed on Dec. 16, 2024. The entire disclosure of the prior application is hereby incorporated by reference in its entirety.

### TECHNICAL FIELD

Embodiments of the present disclosure relate to the field of computer and artificial intelligence technologies, and in particular, to an information processing method, an apparatus, and a device.

### BACKGROUND

More and more applications provide users with search functions, through which the users may quickly acquire knowledge and information.

### SUMMARY

Embodiments of the present disclosure provide an information processing method, an apparatus, and a device.

In a first aspect, an embodiment of the present disclosure provides an information processing method, including: receiving search content input by a user, performing search according to the search content, and invoking a content generation model to generate reply content for the search content; parsing whether the user has a need to acquire the reply content according to the search content, and determining an arrangement order of a search result and the reply content according to a parsing result; and displaying the search result and the reply content according to the arrangement order.

In a second aspect, an embodiment of the present disclosure provides an information processing apparatus, including: a receiving unit, configured to receive search content input by a user, perform search according to the search content, and invoke a content generation model to generate reply content for the search content; a parsing unit, configured to parse whether the user has a need to acquire the reply content according to the search content, and determine an arrangement order of a search result and the reply content according to a parsing result; and a display unit, configured to display the search result and the reply content according to the arrangement order.

In a third aspect, an embodiment of the present disclosure provides an electronic device, including: a processor and a memory;
the memory stores a computer-executable instruction; and
the processor executes the computer-executable instruction stored in the memory, to cause the at least one processor to execute the method according to the first aspect and various possible designs of the first aspect.

In a fourth aspect, an embodiment of the present disclosure provides a computer-readable storage medium, where the computer-readable storage medium stores a computer-executable instruction therein, and when a processor executes the computer-executable instruction, the method according to the first aspect and various possible designs of the first aspect is implemented.

In a fifth aspect, an embodiment of the present disclosure provides a computer program product, including a computer program, where when the computer program is executed by a processor, the method according to the first aspect and various possible designs of the first aspect is implemented.

### BRIEF DESCRIPTION OF THE DRAWINGS

In order to more clearly describe the technical solutions in the embodiments of the present disclosure or in the prior art, the following will briefly introduce the drawings that need to be used in the description of the embodiments or the prior art. Obviously, the drawings in the following description are some embodiments of the present disclosure. For those of ordinary skill in the art, other drawings may be obtained based on these drawings without creative efforts.

FIG. 1 is a first schematic flowchart of an information processing method provided by an embodiment of the present disclosure;

FIG. 2 is a second schematic flowchart of an information processing method provided by an embodiment of the present disclosure;

FIG. 3 is a third schematic flowchart of an information processing method provided by an embodiment of the present disclosure;

FIG. 4 is a structural block diagram of an information processing apparatus provided by an embodiment of the present disclosure; and

FIG. 5 is a schematic diagram of a hardware structure of an electronic device provided by an embodiment of the present disclosure.

### DETAILED DESCRIPTION

In order to make the objectives, technical solutions, and advantages of the embodiments of the present disclosure clearer, the technical solutions in the embodiments of the present disclosure will be clearly and completely described below with reference to the drawings in the embodiments of the present disclosure. Obviously, the described embodiments are part of the embodiments of the present disclosure, but not all of the embodiments. Based on the embodiments in the present disclosure, all other embodiments obtained by those of ordinary skill in the art without creative efforts shall fall within the protection scope of the present disclosure.

It should be noted that the search content input by the user, the locally stored data, and the network stored data are all encrypted in storage. When processing the search content and the search result, the processing is encrypted, and the original search content and search result will not be seen, and no user information will be leaked.

Some applications, such as search engine applications, provide search functions that may give search results after the users input search requests, and may also give reply content generated by models according to the search requests. These applications usually display the reply content before the search results, which cannot meet the needs of the users to quickly acquire the required information in a cooperative office scenario, resulting in a low efficiency of the users to acquire corresponding information through search.

Generally, when a user inputs a search request in a search engine, the search engine may set the reply content given by a model for the search request at the top position, and display one or more search results under the reply content. Such a presentation makes it possible for the user to browse the reply content first, and then browse the search result displayed following the reply content.

In some application scenarios, such as a cooperative office scenario, multiple users use a cooperative office application to implement cooperative office. The cooperative office application may support the multiple users to perform information interaction, and generate internal documents, meeting records, interaction message records, etc. of the multiple users. In addition, the cooperative office application may provide a search function. The search function supports local search, search of internal data of a user group composed of the multiple users, and the like. In the cooperative office application, if a user initiates a search through the cooperative office application, the user may aim to search for a contact, search for historical interaction messages, or search for shared data in the user group. In addition, the cooperative office application may also invoke a model to generate corresponding reply content according to the search content.

Therefore, if the reply content generated by the model is displayed at the top position according to the presentation of the search engine, it may result in the user being unable to browse the information to be searched for in a timely manner, resulting in low efficiency of the user to acquire information.

The information processing method, the apparatus, and the device provided by the embodiments include: receiving search content input by a user, performing search according to the search content, and invoking a content generation model to generate reply content for the search content; parsing whether the user has a need to acquire the reply content according to the search content, and determining an arrangement order of a search result and the reply content according to a parsing result; and displaying the search result and the reply content according to the arrangement order, so that response content to the search content presented to the user and a presentation position of each piece of the response content are helpful for the user to acquire required information, and efficiency of the user to acquire the required information may be improved.

According to the information processing method, the apparatus, and the device provided by the present disclosure, whether the user has a need to acquire an intelligent reply is determined based on the search content, and the arrangement order of the search result and the intelligent reply is determined according to whether there is the need to acquire the intelligent reply, so that the response content to the search content presented to the user and the presentation position of each piece of the response content are helpful for the user to acquire the required information, and the efficiency of the user to acquire the required information may be improved.

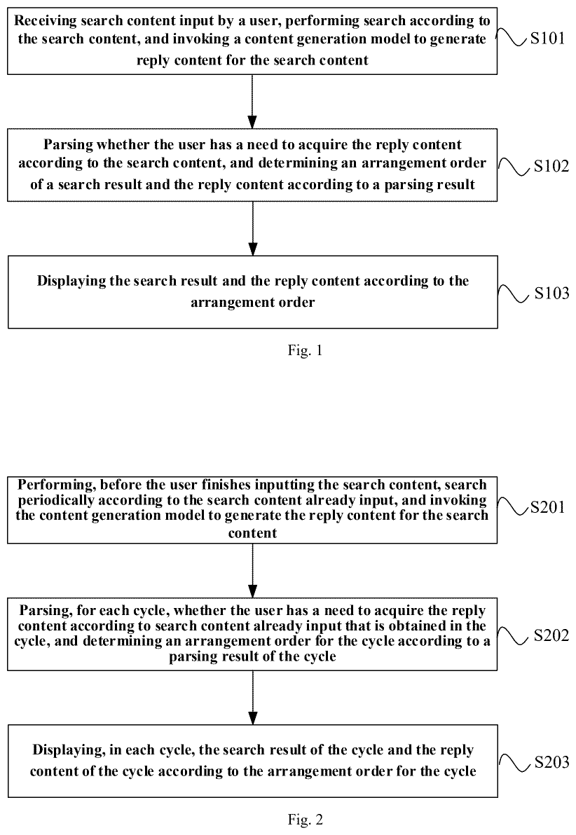

Referring to FIG. 1, FIG. 1 is a first schematic flowchart of an information processing method provided by an embodiment of the present disclosure. As shown in FIG. 1, the method includes:
S101: receiving search content input by a user, performing search according to the search content, and invoking a content generation model to generate reply content for the search content.

In this embodiment, an execution body (such as a terminal device) of the information processing method may run various application clients. The application client may be, for example, a cooperative office application client.

The user may input search content in the application client, for example, trigger a search box in the application client and input the search content in the search box.

The execution body may perform search according to the search content already input by the user, to acquire a search result. The execution body also sends the search content already input to the content generation model, and the content generation model generates reply content according to the search content.

The content generation model may be various pre-trained models that be able to process input content and generate reply content.

In some application scenarios, the execution body may search the network for one or more search results related to the search content already input, and send these search results to the content generation model, and the content generation model generates reply content according to the search results.

The network may be, for example, an internal network used by a user group to which the user belongs. The knowledge base within the user group may be accessed through the network, and the knowledge base may include, for example, documents shared within the user group. The search result sent to the content generation model may include, for example, knowledge content searched out from the knowledge base of the user group.
S102: parsing whether the user has a need to acquire the reply content according to the search content, and determining an arrangement order of the search result and the reply content according to a parsing result.

After receiving the search request, the execution body may parse the search request to determine whether the user has the need to acquire the reply content generated by the content generation model.

For example, a rule for determining whether the user has the need to acquire the reply content may be set in advance, and the search content already input may be evaluated according to the rule to determine whether the user has the need to acquire the reply content.

Illustratively, the rule may include one or more of the following:
determining that the user has a need to acquire the reply content if the input search content is an interrogative sentence and/or an imperative sentence;
determining that the user has a need to acquire the reply content if the search content includes at least part of a name of shared content of the user group such as a specification, a standard, and a template of the user group; and
determining that the user has a need to acquire the reply content if a grammatical structure of the search content meets a preset grammatical structure requirement, for example, the search content includes a combination of a verb and a name.

By using the rule to parse the search content, it may be determined whether the user has the need to acquire the reply content.
S103: displaying the search result and the reply content according to the arrangement order.

After the arrangement order is determined, the search result and the reply content may be displayed according to the determined arrangement order. Therefore, when the user has the need to acquire the reply content, the reply content may be displayed at a position in a window suitable for the user to browse. In an example, the reply content and the search result may be sequentially displayed in the window from top to bottom. The reply content is displayed above the search result, so that the user may quickly browse the reply content.

When the user does not have the need to acquire the reply content, the user has a greater need to acquire other objects such as a contact and a message record, therefore, the search result may be displayed at a position in the window suitable for the user to browse. In an example, the search result and the reply content may be sequentially displayed in the window from top to bottom. That is, the search result is displayed above the reply content, so that the user may quickly acquire information related to his/her needs from the search result.

In this embodiment, in response to the search request of the user, it is possible to perform search for the search request and invoke the content generation model to generate the reply content for the search request, and at the same time to parse whether the user has the need to acquire the reply content, and adjust the arrangement order of the search result and the reply content according to the parsing result, and display the search result and the reply content according to the arrangement order. Therefore, the arrangement order of the search result and the reply content may be determined according to the search needs of the user, and the search result and the reply content displayed according to the arrangement order are helpful for the user to quickly acquire the required information, and the efficiency of the user to acquire the required information may be improved.

Referring to FIG. 2, FIG. 2 is a second schematic flowchart of an information processing method provided by the present disclosure. As shown in FIG. 2, the method includes the following steps:
S201: performing, before the user finishes inputting the search content, search periodically according to search content already input, and invoking the content generation model to generate the reply content for the search content.

When it is received that the search box is triggered and input is performed in the search box, it may be deemed that the search content input by the user starts to be received. When the user continuously inputs the search content in the search box, the search content input by the user is also constantly changing.

In each cycle, historically obtained search result may be continued to be used, corrected, etc., and historical reply content may also be continued to be used, corrected, etc. Since the execution body periodically initiates search and invokes the model to generate the reply content in the background while the user inputs the search content, the final search result and the reply content may be quickly obtained when the user finishes inputting the search request.

The execution body may periodically acquire the search content already input by the user while the user inputs the search content in the search box. For example, the search content already input (for example, all the content currently input by the user) is acquired every preset time period. At the beginning of each cycle, the execution body may acquire the search content already input corresponding to the cycle, perform search according to the search content already input acquired this time, to obtain search result of the cycle; and input the search content already input into the content generation model, and the content generation model outputs the reply content corresponding to the cycle.
S202: parsing, for each cycle, whether the user has a need to acquire the reply content according to search content already input that is obtained in the cycle, and determining an arrangement order for the cycle according to a parsing result of the cycle.
S203: displaying, in each cycle, the search result of the cycle and the reply content of the cycle according to the arrangement order for the cycle.

For each cycle, when performing search and reply content generation for the search content already input in the cycle, it is also possible to parse whether the user has the need to acquire the reply content according to the search content already input.

In an example, if it is determined that the user has the need to acquire the reply content in the cycle, it is determined that the reply content is arrangement ordered to be displayed before the search result in the cycle. If it is determined that the user does not have the need to acquire the reply content in the cycle, it is determined that the reply content is arrangement ordered to be displayed after the search result in the cycle.

In this embodiment, while the user inputs the search content, by performing search and generating the reply content periodically according to the search content already input, and determining the arrangement order of the search result and the reply content according to the search content already input, the arrangement order of the search result and the reply content may be dynamically adjusted, so that the user gradually adjusts the input according to the dynamic arrangement order, thereby guiding the user to input the final search content that may meet the requirements, and the efficiency of the user to acquire the required information may be further improved.

In some embodiments, performing search according to the search content includes:
performing local search according to the search content; and
performing network search according to the search content.

The search content may be used to perform search in locally stored data, and at least one local search result may be obtained, or no local search result may be found. For example, the search content may be matched against locally stored contact information, and if the matching is successful, an identifier of the contact may be used as a local search result. The identifier of the contact that has been successfully matched may be displayed. A chat with the contact may be initiated through the identifier of the contact, so that there is no need to search for the contact one by one among a large number of contacts.

It is also possible to search for chat messages of chats with different users, which may include a private chat and a group chat. For example, the search content is matched against locally stored chat messages. One or more chat messages that are successfully matched are used as a local search result. The chat message that is successfully matched with the search content may be displayed.

The search content may be used to perform network search, a preset knowledge base (for example, a knowledge base corresponding to a user group) authorized by the execution body may be accessed through the network, and at least one search result from the network may be obtained through the network search.

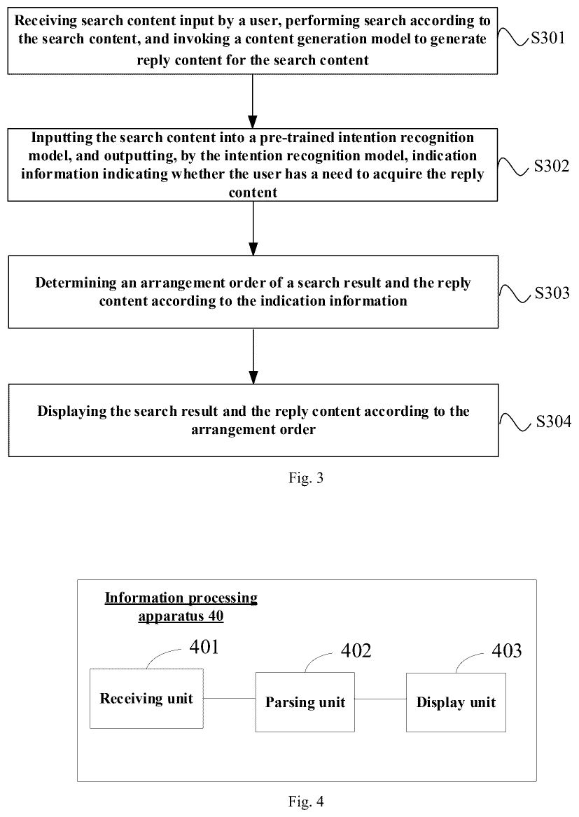

Referring to FIG. 3, FIG. 3 is a third schematic flowchart of an information processing method provided by the present disclosure. As shown in FIG. 3, the method includes the following steps:
S301: receiving search content input by a user, performing search according to the search content, and invoking a content generation model to generate reply content for the search content.

For the specific implementation of step S301, reference may be made to the description of relevant parts in FIG. 1 or FIG. 2, which will not be repeated here.

It may be understood that the embodiment shown in FIG. 3 may be a search and response display process in one cycle in the embodiment shown in FIG. 2.
S302: inputting the search content into a pre-trained intention recognition model, and outputting, by the intention recognition model, indication information indicating whether the user has the need to acquire the reply content.

The execution body (such as a terminal device) of this embodiment may input the search content already input by the user into the intention recognition model. The intention recognition model may be any model that may process natural language.

Multiple pieces of training data may be constructed in advance by simulating search content of the user (including multiple pieces of first training data representing that the user has a need to acquire the reply content and multiple pieces of second training data representing that the user does not have the need to acquire the reply content), and the intention recognition model is trained in advance using the first training data and the second training data to obtain a trained intention recognition model.

In some embodiments, step S302 includes:
in response to the search content meeting a first preset condition, inputting the search content into the intention recognition model, and outputting the indication information by the intention recognition model.

In these embodiments, the first preset condition may be set in advance. It may be periodically determined whether the search content meets the first preset condition, and if the current search content meets the first preset condition, the search content is input into the intention recognition model, and the intention recognition model output indicates whether the user has the need to acquire the reply content. By inputting the search content that meets the first preset condition into the intention recognition model for processing, the amount of data to be processed by the intention recognition model may be reduced, and the load of the intention recognition model may be reduced.

In these embodiments, if the search content does not meet the first preset condition, it may be determined that the user does not have the need to acquire the reply content.

Further, the first preset condition includes that the character length is greater than a character length threshold.

The character length threshold may be set according to a specific application scenario, which is not limited here. Illustratively, the character length threshold may be, for example, 10 characters.

Therefore, as the search content input by the user increases from less to more, the response content (including the search result and the reply content) presented to the user will change, and in addition, the arrangement order of different response content will also change.

By inputting the search content into the intention recognition model when the number of characters is greater than the character length threshold, the load of the intention recognition model may be effectively reduced.
S303: determining the arrangement order of the search result and the reply content according to the indication information.

The arrangement order refers to an order in which the search result and the reply content are arranged from top to bottom, or an order in which the search result and the reply content are arranged from left to right, or an order in which the search result and the reply content are arranged from right to left, in a display page or a display window when displayed on a display interface. Taking the arrangement from top to bottom as an example, the response content with an earlier arrangement order is displayed above the response content with a later arrangement order.
S304: displaying the search result and the reply content according to the arrangement order.

For example, the search result and the reply content may be arranged from top to bottom according to the arrangement order of the search result and the reply content.

In some implementations, the search result includes a local search result and a network search result, and step S303 includes:
if the parsing result indicates that the user has the need to acquire the reply content, determining that the arrangement order includes that the local search result is ordered before the reply content, and the reply content is ordered before the network search result.

In an example, the search result includes a local search result and a network search result, and if the indication information indicates that the user has the need to acquire the reply content, the arrangement order of the local search result, the network search result, and the reply content may be that the local search result is ordered before the reply content, and the reply content is ordered before the network search result.

In this example, if the local search result matching the search content is found on the terminal device side, it may be considered that the probability that the user expects to acquire the local search result is greater, therefore, the arrangement order of the local search result may be set to be before the arrangement order of the reply content.

In some implementations, the local search result includes a first local search result and a second local search result, the first local search result is contact identifier, and the second local search result includes other local search results other than the contact identifier, and step S303 includes:
if the parsing result indicates that the user has the need to acquire the reply content, determining that the arrangement order includes that the first local search result is ordered before the reply content, the reply content is ordered before the second local search result, and the second local search result is ordered before the network search result; and
if the parsing result indicates that the user does not have the need to acquire the reply content, determining that the arrangement order includes that the first local search result is ordered before the second local search result, the second local search result is ordered before the reply content, and the reply content is ordered before the network search result.

In an example, the search result includes a local search result and a network search result. If the indication information indicates that the user does not have the need to acquire the reply content, the arrangement order of the local search result, the network search result, and the reply content may be that the local search result is ordered before the reply content, and the reply content is ordered before the network search result.

In an example, the local search result includes a first local search result and a second local search result, where the first local search result is contact identifier, and the second local search result includes other local search results other than the contact identifier.

If the indication information indicates that the user has the need to acquire the reply content, the arrangement order of the search result and the reply content may be that the first local search result is ordered before the reply content, the reply content is ordered before the second local search result, and the second local search result is ordered before the network search result.

In an example, the local search result includes a first local search result and a second local search result; and if the indication information indicates that the user does not have the need to acquire the reply content, the arrangement order of the first local search result, the second local search result, the reply content, and the network search result may be that the first local search result is ordered before the second local search result, the second local search result is ordered before the reply content, and the reply content is ordered before the network search result.

In this embodiment, it is described that the intention recognition model is used to determine whether the user has the need to acquire the reply content according to the search content already input, which may improve the efficiency of determining whether the user has the need, so that the display of the response content may be adjusted in time. In addition, the arrangement order of different search results and the reply content under different needs of the user is also described, and the user may quickly acquire response content matching the different needs from the displayed response content, which is helpful to further improve the efficiency of the user to acquire required information.

Corresponding to the information processing method of the embodiment in FIG. 1 above, FIG. 4 is a structural block diagram of an information processing apparatus provided by an embodiment of the present disclosure. For convenience of explanation, only parts related to the embodiments of the present disclosure are shown. Referring to FIG. 4, the apparatus includes: a receiving unit 401, a parsing unit 402, and a display unit 402.

The receiving unit 401 is configured to receive search content input by a user, perform search according to the search content, and invoke a content generation model to generate reply content for the search content;
the parsing unit 402 is configured to parse whether the user has a need to acquire the reply content according to the search content, and determine an arrangement order of a search result and the reply content according to a parsing result; and
the display unit 403 is configured to display the search result and the reply content according to the arrangement order.

In some embodiments, the receiving unit 401 is further configured to, before the user finishes inputting the search content, perform search periodically according to search content already input and invoke the content generation model to generate the reply content;
the parsing unit 402 is further configured to, for each cycle, parse whether the user has the need to acquire the reply content according to search content already input that is obtained in the cycle, and determine an arrangement order for the cycle according to a parsing result of the cycle; and
the display unit 403 is further configured to, in each cycle, display the search result of the cycle and the reply content of the cycle according to the arrangement order for the cycle.

In some embodiments, the receiving unit 401 is further configured to:
perform local search according to the search content; and
perform network search according to the search content.

In some implementations, the parsing unit 402 is further configured to input the search content into a pre-trained intention recognition model, and output, by the intention recognition model, indication information indicating whether the user has the need to acquire the reply content; and
determine the arrangement order of the search result and the reply content according to the indication information.

In some implementations, the parsing unit 402 is further configured to:
in response to the search content meeting a first preset condition, input the search content into the intention recognition model, and output the indication information by the intention recognition model.

In some implementations, the first preset condition includes:
a character length greater than a character length threshold.

In some implementations, the search result includes a local search result and a network search result, and the parsing unit 402 is further configured to: if the parsing result indicates that the user has the need to acquire the reply content, determine an arrangement order in which the local search result is ordered before the reply content and the reply content is ordered before the network search result.

In some implementations, the local search result includes a first local search result and a second local search result, the first local search result is contact identifier, and the second local search result includes other local search results other than the contact identifier, and the parsing unit 402 is further configured to:
if the parsing result indicates that the user has the need to acquire the reply content, determine an arrangement order in which the first local search result is ordered before the reply content, the reply content is ordered before the second local search result, and the second local search result is ordered before the network search result; and
if the parsing result indicates that the user does not have the need to acquire the reply content, determine an arrangement order in which the first local search result is ordered before the second local search result, the second local search result is ordered before the reply content, and the reply content is ordered before the network search result.

In order to implement the above embodiments, an embodiment of the present disclosure further provides an electronic device.

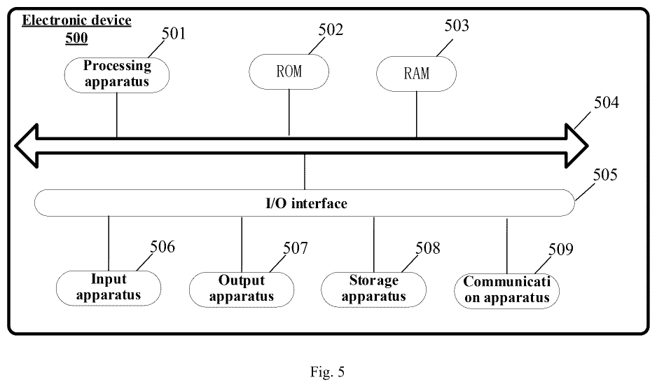

Referring to FIG. 5, FIG. 5 shows a schematic structural diagram of an electronic device 500 suitable for implementing an embodiment of the present disclosure, and the electronic device 500 may be a terminal device or a server. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), a vehicle-mounted terminal (such as a vehicle navigation terminal), etc., and fixed terminals such as a digital TV, a desktop computer, etc. The electronic device shown in FIG. 5 is only an example, and should not impose any limitation on the function and scope of use of the embodiments of the present disclosure.

As shown in FIG. 5, the electronic device 500 may include a processing apparatus (such as a central processing unit, a graphics processor, etc.) 501, which may perform various appropriate actions and processing according to a program stored in a read-only memory (abbreviated as ROM) 502 or a program loaded from a storage apparatus 508 into a random access memory (abbreviated as RAM) 503. In the RAM 503, various programs and data required for operations of the electronic device 500 are also stored. The processing apparatus 501, the ROM 502, and the RAM 503 are connected to each other through a bus 504. An input/output (I/O) interface 505 is also connected to the bus 504.

Usually, the following apparatuses may be connected to the I/O interface 505: an input apparatus 506 including, for example, a touch screen, a touchpad, a keyboard, a mouse, a camera, a microphone, an accelerometer, a gyroscope, etc. ; an output apparatus 507 including, for example, a liquid crystal display (Liquid Crystal Display, LCD for short), a speaker, a vibrator, etc. ; a storage apparatus 508 including, for example, a magnetic tape, a hard disk, etc. ; and a communication apparatus 509. The communication apparatus 509 may allow the electronic device 500 to perform wireless or wired communication with other devices to exchange data. Although FIG. 5 shows the electronic device 500 having various apparatuses, it should be understood that not all of the apparatuses shown here need to be implemented or provided. More or fewer apparatuses may be implemented or provided alternatively.

In particular, according to an embodiment of the present disclosure, the process described above with reference to the flowchart may be implemented as a computer software program. For example, an embodiment of the present disclosure includes a computer program product, which includes a computer program carried on a computer-readable medium, and the computer program contains program code for executing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the preceding functions defined in the method of the embodiment of the present disclosure are executed.

It should be noted that the preceding computer-readable medium in the present disclosure may be a computer-readable signal medium, a computer-readable storage medium, or any combination thereof. The computer-readable storage medium may be, for example, but not limited to, an electronic, magnetic, optical, electromagnetic, infrared, or semiconductor system, apparatus, device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or used in combination with an instruction execution system, apparatus, or device. In the present disclosure, the computer-readable signal medium may include a data signal propagated on a baseband or as a part of a carrier, and computer-readable program code is carried therein. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including, but not limited to, a wire, an optical cable, a radio frequency (RF), or any suitable combination thereof.

The computer-readable medium may be contained in the electronic device or may exist alone without being assembled into the electronic device.

The computer-readable medium carries one or more programs (computer-executable instructions), and when the one or more programs are executed by the electronic device, the electronic device executes the method shown in the preceding embodiments.

Computer program code for executing the operations in the present disclosure may be written in one or more programming languages or combination thereof, where the one or more programming languages include object-oriented programming languages such as Java, Smalltalk, and C++, and further include conventional procedural programming languages such as C or similar programming languages. The program code may be entirely executed on a computer of a user, partly executed on a computer of a user, executed as an independent software package, partly executed on a computer of a user and partly executed on a remote computer, or entirely executed on a remote computer or a server. In the case of involving the remote computer, the remote computer may be connected to a computer of a user through any type of network, including a local area network (abbreviated as LAN) or a wide area network (abbreviated as WAN), or may be connected to an external computer (for example, connected through the Internet using Internet services provided by an Internet service provider).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of code, which includes one or more executable instructions for implementing the specified logical function(s). It should also be noted that, in some alternative implementations, the functions noted in the block may occur in an order different from that noted in the drawings. For example, two blocks shown in succession may, in fact, be executed substantially concurrently, or the blocks may sometimes be executed in a reverse order, depending upon the functionality involved. It will also be noted that each block of the block diagrams and/or flowcharts, and combinations of blocks in the block diagrams and/or flowcharts, may be implemented by special purpose hardware-based systems that perform the specified functions or operations, or combinations of special purpose hardware and computer instructions.

The units involved in the embodiments of the present disclosure may be implemented by software or hardware. The name of a unit does not constitute a limitation on the unit itself under certain circumstances, for example, a first acquisition unit may also be described as “a unit for acquiring at least two internet protocol addresses”.

The functions described above may be performed at least in part by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logical device (CPLD) and so on.

The preceding description is only an explanation of better embodiments of the present disclosure and the technical principles employed. Those skilled in the art should understand that the scope of disclosure involved in the present disclosure is not limited to the technical solutions formed by the specific combination of the preceding technical features, and should also cover, without departing from the preceding concept of disclosure, other technical solutions formed by any combination of the preceding technical features or equivalent features thereof, for example, technical solutions formed by replacing the preceding features with technical features with similar functions disclosed in the present disclosure (but not limited thereto).

In addition, although the operations have been described in a particular order, this should not be understood as requiring the operations to be performed in the particular order shown or in a sequential order. Under certain circumstances, multitasking and parallel processing may be advantageous. Similarly, although the preceding discussion contains several specific implementation details, these should not be interpreted as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only exemplary forms for implementing the claims.

What is claimed is

1. An information processing method, comprising:
receiving search content input by a user, performing search according to the search content, and invoking a content generation model to generate reply content for the search content;
parsing whether the user has a need to acquire the reply content according to the search content, and determining an arrangement order of a search result and the reply content according to a parsing result; and
displaying the search result and the reply content according to the arrangement order.

2. The method of claim 1, wherein the receiving search content input by a user, performing search according to the search content, and invoking a content generation model to generate reply content for the search content comprises:
before the user finishes inputting the search content, performing search periodically according to search content already input and invoking the content generation model to generate the reply content;
the parsing whether the user has a need to acquire the reply content according to the search content, and determining an arrangement order of a search result and the reply content according to a parsing result comprises:
for each cycle, parsing whether the user has the need to acquire the reply content according to search content already input that is obtained in the cycle, and determining the arrangement order for the cycle according to a parsing result of the cycle; and
the displaying the search result and the reply content according to the arrangement order comprises:
in each cycle, displaying the search result of the cycle and the reply content of the cycle according to the arrangement order for the cycle.

3. The method of claim 1, wherein the performing search according to the search content comprises:
performing local search according to the search content; and
performing network search according to the search content.

4. The method of claim 1, wherein the parsing whether the user has a need to acquire the reply content according to the search content, and determining an arrangement order of a search result and the reply content according to a parsing result comprises:
inputting the search content into a pre-trained intention recognition model, and outputting, by the intention recognition model, indication information indicating whether the user has the need to acquire the reply content; and
determining the arrangement order of the search result and the reply content according to the indication information.

5. The method of claim 4, wherein the inputting the search content into a pre-trained intention recognition model, and outputting, by the intention recognition model, indication information indicating whether the user has the need to acquire the reply content comprises:
in response to the search content meeting a first preset condition, inputting the search content into the intention recognition model, and outputting the indication information by the intention recognition model.

6. The method of claim 5, wherein the first preset condition comprises:
a character length greater than a character length threshold.

7. The method of claim 1, wherein the search result comprises a local search result and a network search result, and the determining an arrangement order of a search result and the reply content according to a parsing result comprises:
in response to the parsing result indicating that the user has the need to acquire the reply content, determining an arrangement order in which the local search result is ordered before the reply content and the reply content is ordered before the network search result.

8. The method of claim 1, wherein the search result comprises a local search result and a network search result, the local search result comprises a first local search result and a second local search result, the first local search result is contact identifier, and the second local search result comprises other local search results other than the contact identifier; and the determining an arrangement order of a search result and the reply content according to a parsing result comprises:
in response to the parsing result indicating that the user has the need to acquire the reply content, determining an arrangement order in which the first local search result is ordered before the reply content, the reply content is ordered before the second local search result, and the second local search result is ordered before the network search result; and
in response to the parsing result indicating that the user does not have the need to acquire the reply content, determining the arrangement order to comprise: the first local search result being ordered before the second local search result, the second local search result being ordered before the reply content, and the reply content being ordered before the network search result.

9. An electronic device, comprising: a processor and a memory, wherein
the memory stores a computer-executable instruction; and
the processor executes the computer-executable instruction stored in the memory, to cause the processor to execute an information processing method, comprising:
receiving search content input by a user, performing search according to the search content, and invoking a content generation model to generate reply content for the search content;
parsing whether the user has a need to acquire the reply content according to the search content, and determining an arrangement order of a search result and the reply content according to a parsing result; and
displaying the search result and the reply content according to the arrangement order.

10. The electronic device of claim 9, wherein the receiving search content input by a user, performing search according to the search content, and invoking a content generation model to generate reply content for the search content comprises:
before the user finishes inputting the search content, performing search periodically according to search content already input and invoking the content generation model to generate the reply content;
the parsing whether the user has a need to acquire the reply content according to the search content, and determining an arrangement order of a search result and the reply content according to a parsing result comprises:
for each cycle, parsing whether the user has the need to acquire the reply content according to search content already input that is obtained in the cycle, and determining the arrangement order for the cycle according to a parsing result of the cycle; and
the displaying the search result and the reply content according to the arrangement order comprises:
in each cycle, displaying the search result of the cycle and the reply content of the cycle according to the arrangement order for the cycle.

11. The electronic device of claim 9, wherein the performing search according to the search content comprises:
performing local search according to the search content; and
performing network search according to the search content.

12. The electronic device of claim 9, wherein the parsing whether the user has a need to acquire the reply content according to the search content, and determining an arrangement order of a search result and the reply content according to a parsing result comprises:
inputting the search content into a pre-trained intention recognition model, and outputting, by the intention recognition model, indication information indicating whether the user has the need to acquire the reply content; and
determining the arrangement order of the search result and the reply content according to the indication information.

13. The electronic device of claim 12, wherein the inputting the search content into a pre-trained intention recognition model, and outputting, by the intention recognition model, indication information indicating whether the user has the need to acquire the reply content comprises:
in response to the search content meeting a first preset condition, inputting the search content into the intention recognition model, and outputting the indication information by the intention recognition model.

14. The electronic device of claim 13, wherein the first preset condition comprises:
a character length greater than a character length threshold.

15. The electronic device of claim 9, wherein the search result comprises a local search result and a network search result, and the determining an arrangement order of a search result and the reply content according to a parsing result comprises:
in response to the parsing result indicating that the user has the need to acquire the reply content, determining an arrangement order in which the local search result is ordered before the reply content and the reply content is ordered before the network search result.

16. The electronic device of claim 9, wherein the search result comprises a local search result and a network search result, the local search result comprises a first local search result and a second local search result, the first local search result is contact identifier, and the second local search result comprises other local search results other than the contact identifier; and the determining an arrangement order of a search result and the reply content according to a parsing result comprises:
in response to the parsing result indicating that the user has the need to acquire the reply content, determining an arrangement order in which the first local search result is ordered before the reply content, the reply content is ordered before the second local search result, and the second local search result is ordered before the network search result; and
in response to the parsing result indicating that the user does not have the need to acquire the reply content, determining the arrangement order to comprise: the first local search result being ordered before the second local search result, the second local search result being ordered before the reply content, and the reply content being ordered before the network search result.

17. A non-transitory computer-readable storage medium, wherein the computer-readable storage medium stores a computer-executable instruction therein, which, when executed by a processor, cause the processor to implement an information processing method, comprising:
receiving search content input by a user, performing search according to the search content, and invoking a content generation model to generate reply content for the search content;
parsing whether the user has a need to acquire the reply content according to the search content, and determining an arrangement order of a search result and the reply content according to a parsing result; and
displaying the search result and the reply content according to the arrangement order.

18. The non-transitory computer-readable storage medium of claim 17, wherein the receiving search content input by a user, performing search according to the search content, and invoking a content generation model to generate reply content for the search content comprises:
before the user finishes inputting the search content, performing search periodically according to search content already input and invoking the content generation model to generate the reply content;
the parsing whether the user has a need to acquire the reply content according to the search content, and determining an arrangement order of a search result and the reply content according to a parsing result comprises:
for each cycle, parsing whether the user has the need to acquire the reply content according to search content already input that is obtained in the cycle, and determining the arrangement order for the cycle according to a parsing result of the cycle; and
the displaying the search result and the reply content according to the arrangement order comprises:
in each cycle, displaying the search result of the cycle and the reply content of the cycle according to the arrangement order for the cycle.

19. The non-transitory computer-readable storage medium of claim 17, wherein the performing search according to the search content comprises:
performing local search according to the search content; and
performing network search according to the search content.

20. The non-transitory computer-readable storage medium of claim 17, wherein the parsing whether the user has a need to acquire the reply content according to the search content, and determining an arrangement order of a search result and the reply content according to a parsing result comprises:
inputting the search content into a pre-trained intention recognition model, and outputting, by the intention recognition model, indication information indicating whether the user has the need to acquire the reply content; and
determining the arrangement order of the search result and the reply content according to the indication information.
